(19) United States
(12) Patent Application Publication
(10) Pub. No.: US 2015/0008738 A1
(43) Pub. Date: Jan. 8, 2015

(54) DC POWERED SYSTEM COMBINING DC/AC INVERTER FOR AC POWER AND CONSTANT CURRENT SUPPLIES FOR LED DRIVE FOR ILLUMINATION AND SIGNALING, AND FOR BATTERY CHARGING

(71) Applicant: Muzahid Bin Huda, Los Gatos, CA (US)

(72) Inventor: Muzahid Bin Huda, Los Gatos, CA (US)

(21) Appl. No.: 13/936,080

(22) Filed: Jul. 5, 2013

(51) Int. Cl. H05B 33/08

(52) U.S. Cl. CPC H05B 33/0809
USPC 307/23; 315/246

(57) ABSTRACT

A combined system incorporating one or more DC/AC inverter systems or sub-systems, and one or more constant current sources and/or constant current sinks is disclosed. Various embodiments of this invention simultaneously deliver AC electrical power, as well as source or sink constant current to or from one or more electrical loads. Powered by one or more DC power sources, this invention combines into a single standalone multi-function unit the capability to deliver AC electrical power and also constant source or sink currents for LED lighting for general illumination or signaling, and optionally, also for charging or discharging one or more batteries. Examples of constant current loads driven by this invention include, but are not limited to, visible, infrared or ultra-violet LEDs, laser diodes and batteries of arbitrary composition, construction and voltage/current ratings in controlled charge or discharge mode.

### CROSS REFERENCE TO RELATED APPLICATION

This application claims priority from and incorporates by reference the following US Provisional Application: “DC powered system combining DC/AC inverter for AC power and constant current supplies for LED drive for illumination and signaling, and for battery charging”, Ser. No. 61/668,734 filed on Jul. 6, 2012.

### BACKGROUND OF THE INVENTION

1. Field of the Invention

The field of the present invention pertains to electrical power conversion. This disclosure describes a combined system incorporating of one or more DC/AC inverter systems or sub-systems, and one or more constant current sources and/or constant current sinks. Embodiments of this invention can simultaneously deliver both AC electrical power, and also one or more values of constant current to one or more electrical loads. From one or more DC power sources, this invention combines into a single standalone unit the capability to deliver AC electrical power and also constant currents for LED lighting for general illumination or signaling, and optionally for battery charging or discharging. Examples of constant current loads driven by this invention include, but are not limited to, visible, infrared or ultra-violet LEDs, laser diodes and batteries of arbitrary composition, construction and voltage/current ratings in controlled charge or discharge mode. The output current of the constant current sources and sinks are adjustable to any arbitrary value by mechanical and/or electronic means.

2. Description of Related Art

DC/AC inverters have been designed and commercially manufactured. Examples of constant current sources and sinks used in narrow, limited configurations for LED drive and battery charging are also available. Examples of prior art on DC/AC inverters and constant current supplies for LED drive and battery charging are found in the following patents:
a) U.S. Pat. No. 8,169,151 issued to Kengo Kimura, “DC/AC converter and controller thereof” dated May 1, 2012
b) U.S. Pat. No. 8,143,797 issued to Chung-Che Yu, et al., “DC/AC inverter” dated Mar. 27, 2012
c) U.S. Pat. No. 8,471,493 issued to Poh Weng Yem, et al., “Combination LED driver” dated Jun. 25, 2013
d) U.S. Pat. No. 8,432,136 issued to Kazuhide Ashida, “Battery pack, battery charger, and battery pack system” dated Apr. 30, 2013

The novelty of the present invention is that an arbitrary number of DC/AC inverter systems or sub-systems are combined with an arbitrary number of constant current sources and/or constant current sinks to construct a single, standalone multi-function unit. In this multi-function unit incorporating an arbitrary number of DC/AC inverters, the constant current sources and/or constant current sinks are configured as LED (Light emitting diode) drivers, or alternately, they are configured as at least one LED driver and an arbitrary number of battery chargers and/or controlled battery discharge systems. (Heretofore, battery chargers and controlled battery discharge systems are collectively referred to as “battery chargers” in this disclosure). The power source for the combined unit is a DC power supply of arbitrary voltage and current ratings.

The DC/AC inverters and current sources and/or current sinks of the standalone functional unit are powered from an arbitrary number of internal and/or external dc power sources such as batteries, photovoltaic (PV) panel, AC/DC power adapter, etc. Furthermore, the constant current sources and/or current sinks are powered from either the same, or separate, dc power source or sources as those for the DC/AC inverters.

All known topologies for DC/AC inverters for any arbitrary input and output voltages and currents, as well as any output AC frequency can be implemented in the various embodiments of the present invention. Furthermore, all known topologies for constant current sources and constant current sinks can be implemented in various embodiments of this invention. Such power conversion architectures include, but are not limited to linear, buck, boost, buck-boost, flyback, forward, SEPIC, soft-switching resonant converters, and also all possible variations of these architectures.

### SUMMARY OF THE INVENTION

This invention disclosure describes both the concept as well as multiple embodiments of the combination of one or more DC/AC inverter systems or sub-systems with an arbitrary number of constant current sources or current sinks into a single standalone functional unit to construct a) an AC power source and an LED driver, or b) an AC power source and at least one LED driver, along with an arbitrary number of battery chargers, for the purpose of providing AC power and drive for LED based illumination (LED lighting), and for optional charging or discharging of batteries. The following types of embodiments of the present invention are disclosed:
a) The combination, of an arbitrary number of DC/AC inverters and an arbitrary number of constant current source or constant current sink LED drivers, into a single, standalone functional unit, and
b) The combination, of an arbitrary number of DC/AC inverters, at least one constant current source or constant current sink LED driver, and an arbitrary number of battery chargers incorporating constant current sources and/or constant current sinks, into a single standalone functional unit.

The AC inverter or inverters used in the present invention deliver AC power in any arbitrary number of phases, such as but not limited to, single phase, 2 phase, 3 phase, etc. Furthermore, these inverters deliver any arbitrary AC voltage of fixed or variable frequency and of any arbitrary periodic waveform.

The present invention and its various embodiments are used to implement a self contained power conversion system that simultaneously supplies either fixed or variable frequency and fixed or variable AC voltage or voltages, as well as an arbitrary number of constant current source or sink outputs to drive one or more LEDs and/or also to charge an arbitrary number of batteries. Furthermore, an arbitrary number of optional regulated or unregulated DC voltage sources of any arbitrary voltage are also included in the embodiments of the present invention disclosed.

### BRIEF DESCRIPTION OF THE DRAWINGS

FIG. 1 shows the primary concept of the present invention with block diagrams showing the basic components of the system.

FIG. 2 shows the main functional blocks of the combined DC/AC inverter section and constant current LED driver section.

FIG. 3 shows detailed functional sub-systems of one embodiment of the combined DC/AC inverter section and constant current LED driver section.

FIG. 4 shows detailed functional sub-systems of a second embodiment of the combined DC/AC inverter section and constant current LED driver section.

FIG. 5 shows detailed functional sub-system blocks of one embodiment of the combined DC/AC inverter section, DC powered constant current LED driver and DC powered battery chargers.

FIG. 6 shows detailed functional sub-systems of an embodiment of the combined DC/AC inverter section, DC powered constant current LED driver and DC powered battery chargers.

FIG. 7 shows the front view drawing of one possible implementation of the present invention.

FIG. 8 shows the rear view drawing of one possible implementation of the present invention

### DETAILED DESCRIPTION

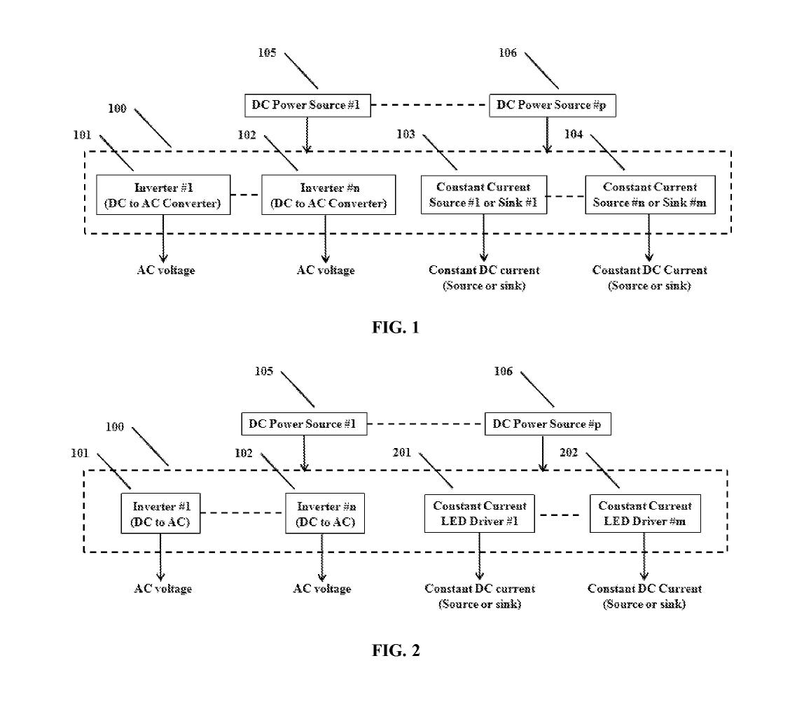

FIG. 1 shows the basic concept of the present invention with the blocks representing the main components. 100 represents the entire system consisting of an arbitrary number of AC/DC inverters, 101 and 102, and an arbitrary number of constant current supplies, 103 and 104. The constant current supplies are either all constant current sources or they are all constant current sinks. Alternately, they are an arbitrary combination of constant sources and sinks. 105 and 106 are an arbitrary number of DC power sources such as, but not limited to batteries, AC/DC rectifiers, DC/DC or AC/DC power converters that are used to power all the functional systems contained in the complete system 100. In one embodiment, all DC power sources represented by 105 and 106 are external to 100. In a second embodiment, all DC power sources represented by 105 and 106 are installed internally to 100. In yet a third embodiment, some of the DC power sources represented by 105 and 106 are installed internally to 100 while the remaining DC power sources represented by 105 and 106 are external to 100.

FIG. 2 shows the basic concept of FIG. 1, but showing that the constant current supplies (sources or sinks) are used as constant current LED drivers (201 and 202). In FIG. 2 as in FIG. 1, 100 represents the entire invention consisting of DC/AC inverters 101 and 102 and the constant current LED drivers 201 and 202. 105 and 106 are the arbitrary number of DC power sources for 100 as described in FIG. 1. The blocks represented by 101, 102, and 201, 202 have an arbitrary number of outputs.

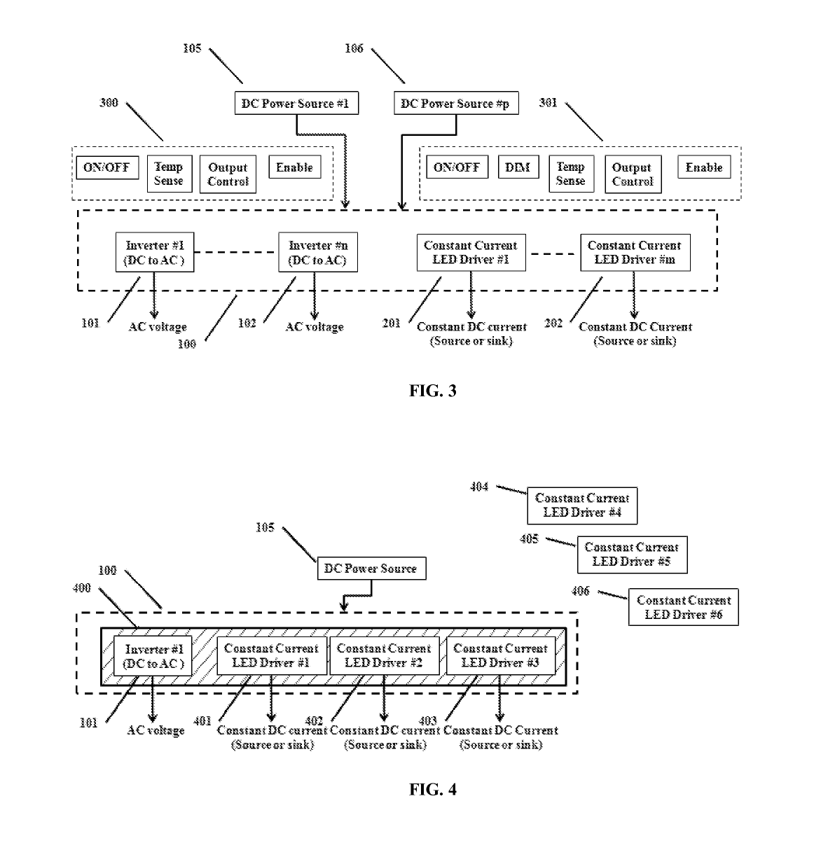

FIG. 3 shows the detailed functional blocks of one embodiment of the present invention. This embodiment is that of the combination of an arbitrary number of DC/AC inverters represented by 101 and 102, and also an arbitrary number of LED drivers represented by 201 and 202. 300 represents some or all the control functions for the DC/AC inverters represented by 101 and 102. Those skilled in the field of the present invention will recognize that other control and auxiliary functions for the blocks represented by 101 and 102 are also possible, and are implied to exist within 300. In one embodiment these control functions are all implemented inside the present invention (the combined system 100). In a second embodiment these control functions are all implemented external to the combined system 100. In a third embodiment some of the functional blocks in 300 are implemented inside the combined system 100. 301 represents some or all the control functions for the LED drivers represented by 201 and 202. Those skilled in the field of the present invention will recognize that other control and auxiliary functions for the blocks represented by 301 are also possible, and are implied to exist within 301. In one embodiment these control functions are all implemented inside the present invention (the combined system 100). In a second embodiment these control functions are all implemented external to the combined system 100. In a third embodiment some of the functional blocks in 301 are implemented inside the combined system 100. An arbitrary number of outputs are implemented for the blocks represented by 101, 102,201 and 202.

FIG. 4 shows another embodiment of this invention. This embodiment is the combination of one DC/AC inverter, 101, and three constant current LED drivers, 401, 402 and 403, implemented in a single, self contained system (The present invention) represented by 100. This system uses an arbitrary number of printed circuit boards (PCBs) to implement all the necessary circuitry for 101, 401, 402 and 403. 400 represents this arbitrary number of PCBs. For example, any of functional circuits represented by 101, 401, 402 and 403 are partially or entirely implemented on a single PCB, or some of these circuits are partially or fully implemented on a single PCB, while the remainder are partially or fully implemented on an arbitrary number of other PCBs; Finally all the circuits represented by 101, 401, 402 and 403 are assembled together into a single functional unit represented by 100. For simplicity, circuitry to implement the control functions of 101, represented by the block 300 of FIG. 3 are not shown explicitly in FIG. 4, and are implied to either exist as part of the circuitry of 101 or as separate standalone circuits working in conjunction with 101. Furthermore, these control circuits are implemented wholly in digital form, wholly in analog form or in mixed signal (combined analog and digital) form.

Also for simplicity, all circuits implementing control functions for 401 402 and 403, represented by the block 301 of FIG. 3, with reference to 201 and 202, are not shown explicitly in FIG. 4, and are implied to either exist as part of the circuitry of 401, 402 and 403, or as separate standalone circuits working in conjunction with 401, 402 and 403. Furthermore, these control circuits are implemented wholly in digital form, wholly in analog form or in mixed signal (combined analog and digital) form. The complete standalone system consists of the circuits implementing all the functional and control blocks described in the block labeled 100. Also in this embodiment, 404, 405 and 406 are three separate, standalone LED drivers that are not an integral part of 400, but are optionally installed to extend the functionality of the present invention (the combined system represented by 100). Any arbitrary number of such standalone LED drivers are optionally mounted to extend the functionality of the present invention. Finally in this embodiment, a single, DC power source 105 is external to the complete system, and is used to power all circuitry incorporated within 100.

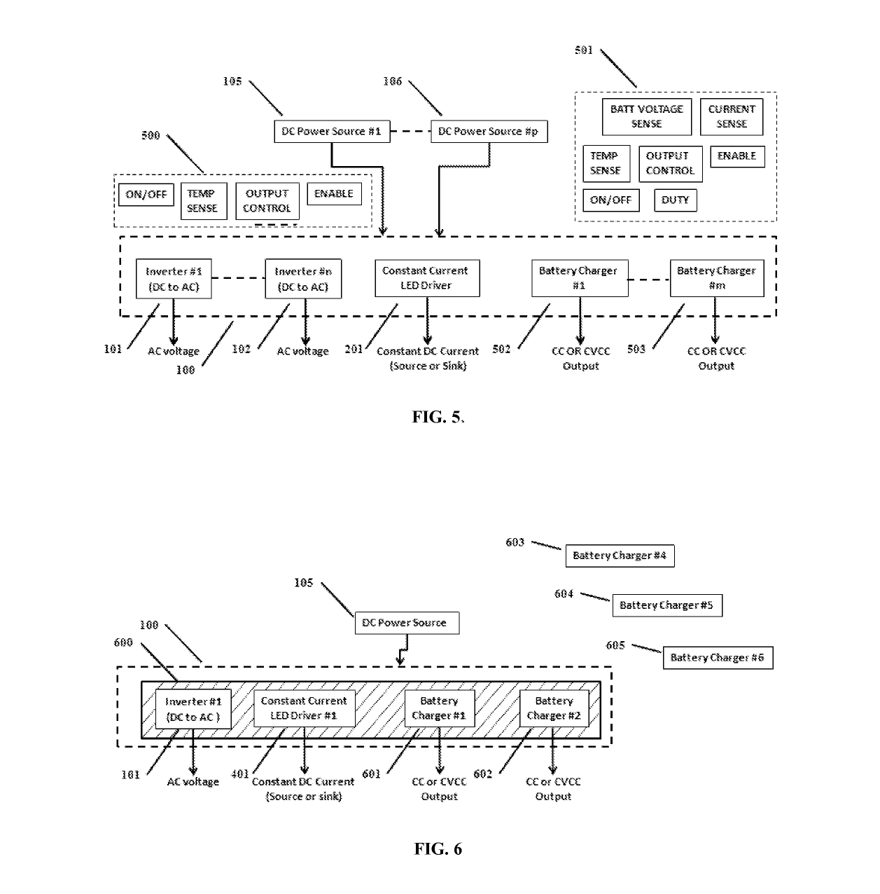

FIG. 5 shows the detailed functional blocks of another embodiment of the present invention. This embodiment is that of the combination of an arbitrary number of DC/AC inverters represented by 101 and 102, at least one constant current LED driver (described in FIG. 2 as 201) and also an arbitrary number of battery chargers represented by 502 and 503. The battery chargers represented by 502 and 503 are a) only of the constant current (CC) type, or b) of the dual, constant current and constant voltage (CVCC) type, or c) of an arbitrary mix of CC and CVCC type. 500 represents some or all the control functions for the DC/AC inverters represented by 101 and 102. Those skilled in the field of the present invention will recognize that other control and auxiliary functions for the blocks represented by 101 and 102 are also possible, and are implied to exist within 500. In one embodiment these control functions are all implemented inside the present invention (the combined system 100). In a second embodiment these control functions are all implemented external to the combined system 100. In a third embodiment some of the functional blocks in 500 are implemented inside the combined system 100. 501 represents some or all the control functions for the battery chargers represented by 502 and 503. Those skilled in the field of the present invention will recognize that other control and auxiliary functions for the blocks represented by 501 are also possible, and are implied to exist within 501. In one embodiment these control functions are all implemented inside the present invention (the combined system 100). In a second embodiment these control functions are all implemented external to the combined system 100. In a third embodiment some of the functional blocks in 501 are implemented inside the combined system 100. An arbitrary number of outputs are implemented for the blocks represented by 101, 102,502 and 503. For simplicity control circuits represented by control block 301 described in FIG. 3 for the LED drivers are not shown, but is implied in this figure. Furthermore, any arbitrary number of LED drivers is implemented in this embodiment.

FIG. 6 shows yet another embodiment of this invention. This embodiment is the combination of one DC/AC inverter 101, at least one constant current LED driver (described in FIG. 4 as 401) and two battery chargers represented by 601 and 602 implemented in a single, self contained system (The present invention) represented by 100. The battery chargers 601, and 602 are implemented either as a) CC type, b) CVCC type or c) an arbitrary combination of CC and CVCC type. This system uses an arbitrary number of printed circuit boards (PCBs) to implement all the necessary circuitry for 101, 401, 601 and 602. 600 represents this arbitrary number of PCBs. For example, any of functional circuits represented by 101, 401, 601 and 602 are partially or entirely implemented on a single PCB, or some of these circuits are partially or fully implemented on a single PCB, while the remainder are partially or fully implemented on an arbitrary number of other PCBs; Finally all the circuits represented by 101, 401, 601 and 602 are assembled together into a single functional unit represented by 100. For simplicity, circuitry to implement the control functions of 101, represented by the block 500 of FIG. 5 are not shown explicitly in FIG. 6, but are implied to either exist as part of the circuitry of 101 or as separate standalone circuits working in conjunction with 101. Furthermore, these control circuits are implemented wholly in digital form, wholly in analog form or in mixed signal (combined analog and digital) form.

Also for simplicity, circuits implementing some or all the control functions for 401, represented by the block 301 and described in FIG. 3 with reference to 201 and 202, and for 601 and 602, represented by the block 501 of FIG. 5, with reference to 502 and 503, are not shown explicitly in FIG. 6, and are implied to either exist as part of the circuitry of 401, 601 and 602, or as separate standalone circuits working in conjunction with 401, 601 and 602. Furthermore, these control circuits are implemented wholly in digital form, wholly in analog form or in mixed signal (combined analog and digital) form. The complete standalone system consists of the circuits implementing all the functional and control blocks described in the block labeled 100. Also in this embodiment, 603, 604 and 605 are three separate, standalone battery chargers, either of the a) CC type, b) CVCC type or c) an arbitrary combination of CC and CVCC types, that are not an integral part of 600, but are optionally installed as self contained and independent functional units to extend the functionality of the present invention (the combined system represented by 100). Any arbitrary number of such standalone, self contained battery chargers are optionally mounted. Finally in this embodiment, a single, DC power source 105 is external to the complete system, and is used to power all circuitry incorporated within 100, but it will be obvious to those skilled in this field that any arbitrary number of DC power sources may also be used with this embodiment.

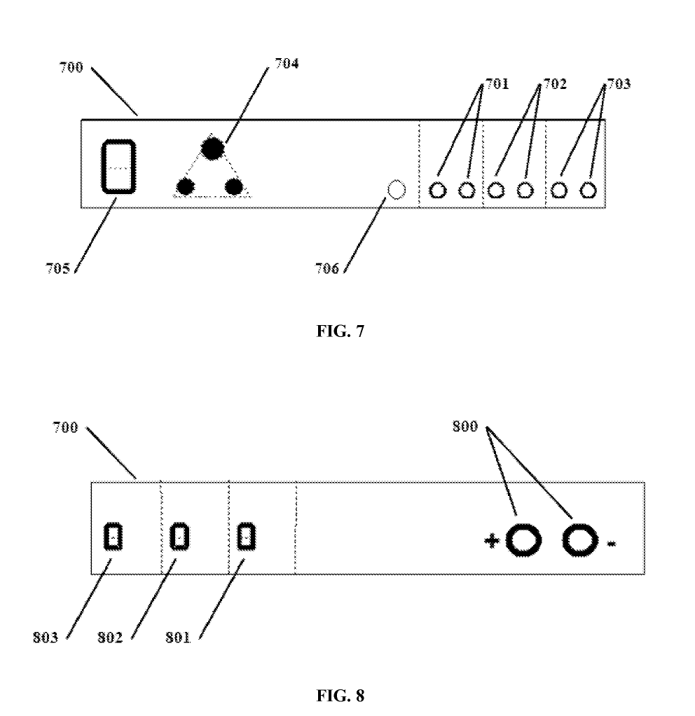

FIG. 7 shows the exterior front view of one possible construction of the present invention. 700 is the external enclosure for, and represents the complete system including all internal systems, sub-systems and circuits, and is analogous to 100 in previous figures. 701, 702 and 703 are three independent output and return connectors for a total of three independent constant current LED drivers and/or battery chargers. Optionally, any arbitrary number of LED driver and/or battery chargers are implemented inside this system along with any arbitrary number of corresponding output connectors. 704 represents the output connector of the DC/AC inverter circuit. 705 is an ON/OFF switch for either the entire system, or for the AC/DC inverter. 706 is an auxiliary indicator such as a power ON, battery status, fault of other indicator.

FIG. 8 shows one possible exterior rear view of the unit shown in FIG. 7. 700 is the external enclosure (described in FIG. 7). 800 is the input terminal pair for an external DC power source for the system. Optionally multiple external DC power sources may be used to power this system, along with a corresponding number of input terminal pairs. Furthermore, an arbitrary number of internal DC power sources may also be used to power this unit. 801, 802 and 803 are power ON/OFF switches, each corresponding to one of the constant current LED Drivers and/or battery chargers.

What is claimed is:

1. A standalone, multi-function DC powered system consisting of a DC/AC inverter or multiple DC/AC inverters and an arbitrary number of constant current source or sink LED drivers with the simultaneous capability to generate AC power and drive current for general visible, infrared or ultra-violet LED illumination (LED lighting) and signaling.

2. A standalone, multi-function DC powered system combining a DC/AC inverter or multiple DC/AC inverters, at least one constant current source or sink LED driver, and an arbitrary number of constant current (CC), and/or dual mode constant voltage and constant current (CVCC) battery chargers with the simultaneous capability to generate AC power, drive current for general visible, infrared or ultra-violet LED illumination (LED lighting) and signaling, and also provide controlled charge to or discharge of any number of batteries of arbitrary composition, construction and voltage/current ratings.

3. The output waveforms of the DC/AC inverters of claim 1 and claim 2 are of any arbitrary periodic wave shape, including but not limited to sine, triangular, ramp, square, and square-wave-with-dead-time (“modified sine wave”) shapes.

4. The output waveforms of the DC/AC inverters of claim 1 and claim 2 are of an arbitrary fixed or variable frequency.

5. The output voltage and current of the DC/AC inverters of claim 1 and claim 2 are of arbitrary, fixed or variable magnitude.

6. The totality of the DC powered systems of claim 1 and claim 2 wholly including an arbitrary number of DC power sources for the system internally, or using wholly external power sources, or including and using an arbitrary combination of internal and external power sources.
